(19) United States
(12) Patent Application Publication
(10) Pub. No.: US 2009/0223181 A1
(43) Pub. Date: Sep. 10, 2009

(54) Bridle

(76) Inventor: Raj Mohan, Gaithersburg, MD (US)

Correspondence Address: DINESH AGARWAL, P.C., 5350 SHAWNEE ROAD, SUITE 330, ALEXANDRIA, VA, 22312, US

(21) Appl. No.: 12/073,472

(22) Filed: Mar. 6, 2008

(51) Int. Cl. B68B 1/04

(52) U.S. Cl. 54/6.1

(57) ABSTRACT

A bridle includes a head piece with first and second end portions, and brow and nose bands operably connected to the head piece. An auxiliary strap extends in a channel in the head piece, and passes through the thickness of the head piece adjacent the first and second end portions thereof. A cushion is provided on the underside of the head piece.

### FIELD AND BACKGROUND OF THE INVENTION

The present invention is generally directed to horse equipment and accessories, and more particularly to a bridle.

A bridle is a device for controlling, guiding or restraining a horse. It fits over a horse's head and gives the rider or driver control over the horse. Typically, a bridle includes a bit for positioning in the horse's mouth.

### ASPECTS OF THE INVENTION

The present disclosure is directed to various aspects of the present invention.

One aspect of the present invention includes a bridle having a head piece with first and second end portions, and brow and nose bands operably connected to the head piece. An auxiliary strap extends in a channel in the head piece, and passes through the thickness of the head piece adjacent the first and second end portions thereof. A cushion is provided on the underside of the head piece.

Another aspect of the present invention includes a bridle having a head piece with first and second end portions, a throat piece operably connected to the head piece, and a nose band strap. A portion of the nose band strap extends in a channel provided between first and second laterally spaced head straps of the head piece. A cushion, on the underside of the head piece, is operably connected to the portion of the nose band strap.

### BRIEF DESCRIPTION OF THE DRAWINGS

One of the above and other aspects, novel features and advantages of the present invention will become apparent from the following detailed description of the preferred embodiment(s) invention, as illustrated in the drawings, in which:

FIG. 1 is a perspective view of the bridle of the present invention, shown mounted on a horse's head;

FIG. 2 is an enlarged perspective view of the bridle of the present invention;

FIG. 3 is a partial enlarged view of the head piece of the bridle of the present invention;

FIG. 4 is an enlarged sectional view taken along line 4-4 of FIG. 3;

FIG. 5 is an enlarged sectional view taken along line 5-5 of FIG. 3; and

FIG. 6 is a partial, exploded view, similar to FIG. 3.

### DETAILED DESCRIPTION OF THE PREFERRED EMBODIMENT(S) OF THE INVENTION

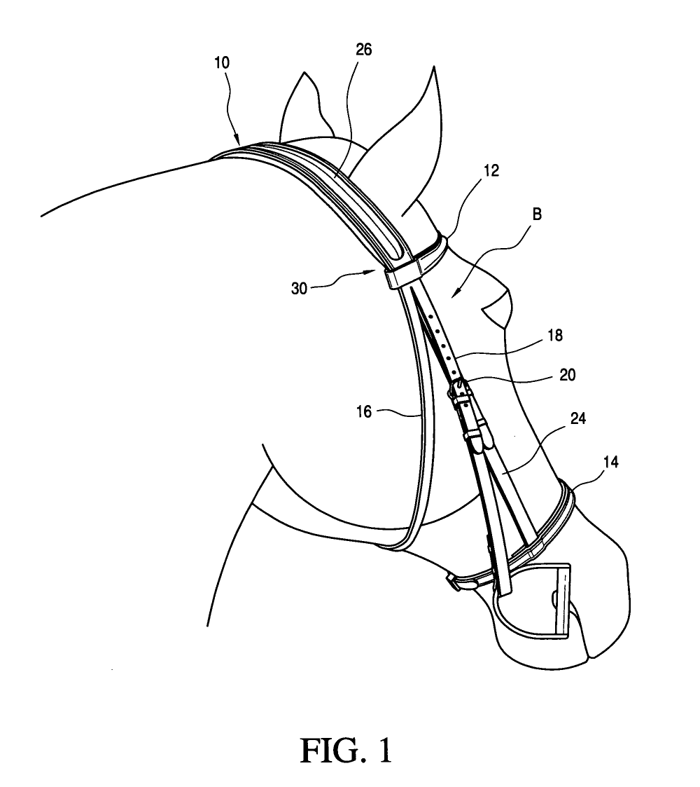

As best shown in FIGS. 1-2, the bridle B of the present invention includes a head piece 10, a brow band 12, and a nose band 14, interconnected in a known manner. Throat and cheek pieces 16 and 18, respectively, are preferably continuous with the head piece 10 and each includes a buckle 20 for varying the length thereof. Left and right nose band straps 22 and 24, respectively, are adjustably connected to the nose band 14, and include a common nose band portion 26 that forms a part of the head piece 10, described below in more detail.

The head piece 10 includes left and right end portions 28 and 30, adjacent to where the brow band 12 is positioned (FIG. 2).

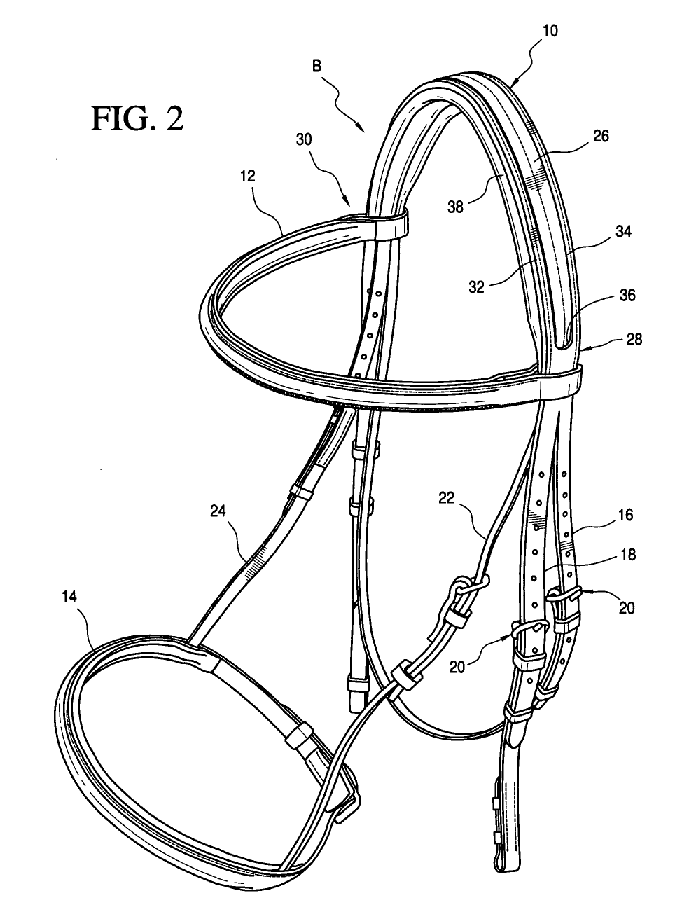

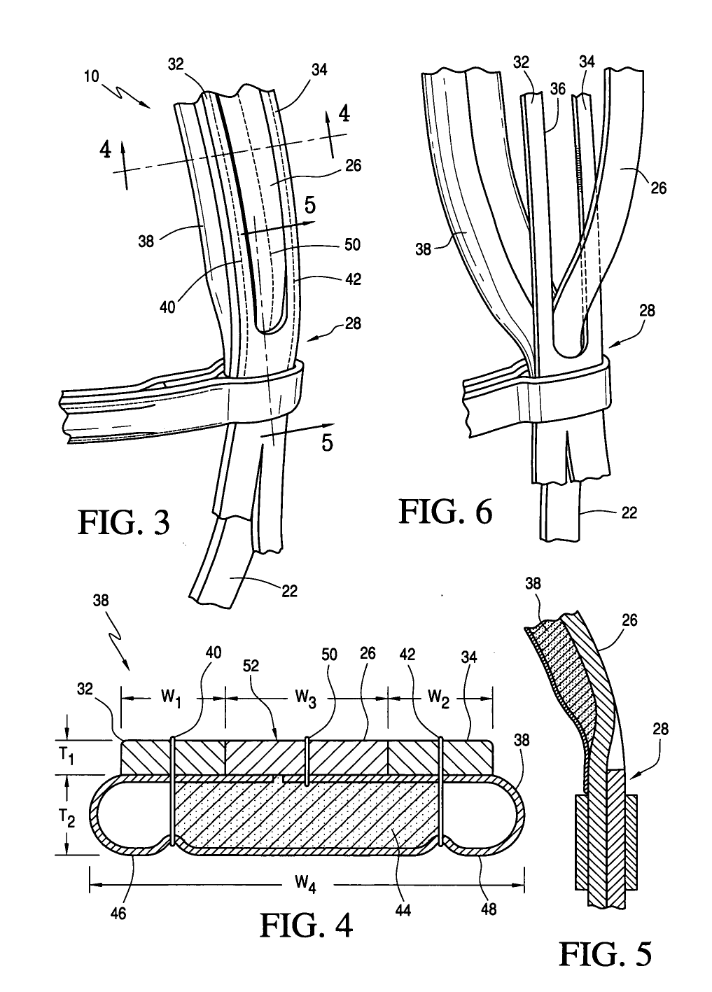

As best shown in FIGS. 3-6, the head piece includes laterally spaced head straps 32 and 34, defining therebetween a channel or slot 36. Preferably, the channel 36 extends through the thickness of the head piece 10 and spans between the left and right end portions 28 and 30 thereof.

As best shown in FIGS. 2 and 3-6, a cushion 38 is provided on the underside of head piece 10 and extends between the left and right end portions 28 and 30.

As best shown in FIG. 4, the cushion 38 is preferably attached to the head straps 32 and 34, by individual stitching 40 and 42, respectively. One of the main purposes of the cushion 38 is to provide comfort to the horse by reducing or preventing friction or irritation caused by direct contact of the head piece 10 with the horse's head. To improve this comfort, the cushion 38 includes a preferably centrally positioned resilient mass 44, and open chambers 46 and 48, one on either side thereof. The cushion 38 is connected to the common nose band portion 26 by a stitching 50.

Preferably, the thickness of each of the head straps 32 and 34, and nose band common portion 26, are substantially the same so as to have a uniform thickness T₁, forming a planar or substantially planar top surface 52. The thickness T₂ of the cushion 38 is preferably more than the thickness T₁, and is preferably twice as much. Preferably, the widths W₁ and W₂ of the head straps 32 and 34, respectively, are substantially the same. However, the width W₃ of the nose band common portion 26 is preferably more than each width W₁ and W₂. On the other hand, preferably the width W₄ of the cushion 38 is substantially equal to or more than the combined total width (W₁+W₂+W₃) of the head straps 32 and 34 and the nose band common portion 26. It is noted herewith that the foregoing dimensions illustrate a preferred embodiment, and can be varied. For instance, widths W₁, W₂, and W₃ can be same or substantially the same. Likewise, the thicknesses T₁ and T₂ can be also be same or substantially the same, and the width W₄ can be less than the combined total width (W₁+W₂+W₃) of the head straps 32 and 34 and the nose band common portion 26.

As best shown in FIGS. 3 and 5, the nose band common portion 26 is recessed in channel 36, and passes through the thickness of the head piece 10 adjacent head piece end portions 28 and 30, so as to run thereunder.

It is noted therewith that it is within the scope of this invention to change the number and/or position of the stitching to assemble the head piece. Likewise, it is within the scope of the invention to use other techniques or structures to complete the assembly of the head piece. Along the same lines, the overall structure/components of the cushion can be varied.

While this invention has been described as having preferred sequences, ranges, steps, materials, structures, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention.

What is claimed is:

1. A bridle, comprising:
a) a head piece including first and second end portions;
b) a brow band operably connected to said head piece;
c) a nose band operably connected to said head piece;
d) said head piece including a channel between said first and second end portions;
e) an auxiliary strap extending in said channel and passing through the thickness of said head piece adjacent said first and second end portions thereof; and
f) a cushion on the underside of said head piece.

2. The bridle of claim 1, further comprising:
a) a nose band operably connected to said auxiliary strap.

3. The bridle of claim 1, wherein:
a) said cushion comprises a resilient mass and an open chamber.

4. The bridle of claim 3, wherein:
a) said auxiliary strap is connected to said resilient mass by stitching.

5. The bridle of claim 1, wherein:
a) the thickness of said cushion is more than the thickness of said head piece.

6. The bridle of claim 5, wherein:
a) said cushion is about twice in thickness than said head piece.

7. The bridle of claim 1, wherein:
a) the width of said cushion is more than the width of said head piece.

8. The bridle of claim 1, wherein:
a) said cushion comprises a central resilient section and two laterally spaced open chambers.

9. A bridle, comprising:
a) a head piece including first and second end portions;
b) a throat piece operably connected to said head piece;
c) a nose band strap;
d) said head piece including first and second laterally spaced head straps defining a channel therebetween;
e) a cushion on the underside of said head piece; and
f) a portion of said nose band strap extending in said channel and being operably connected to said cushion.

10. The bridle of claim 9, wherein:
a) said channel extends between said first and second end portions of said head piece.

11. The bridle of claim 9, wherein:
a) said portion of said nose band strap extends between said first and second end portions of said head piece.

12. The bridle of claim 11, wherein:
a) said cushion comprises a central foam section and two laterally spaced open chambers.

13. The bridle of claim 12, wherein:
a) said portion of said nose band strap is connected to said foam section by stitching.

14. The bridle of claim 11, wherein:
a) said head straps are connected to said cushion by stitching.

15. The bridle of claim 9, wherein:
a) the width of said portion of said nose band strap is more than the width of at least one of said head straps.

16. The bridle of claim 9, wherein:
a) the width of said portion of said nose band strap is more than the width of each of said head straps.

17. The bridle of claim 9, wherein:
a) the width of said cushion is more than the total width of said portion of said nose band strap and said head straps.

18. The bridle of claim 9, wherein:
a) the thickness of said cushion is more than the thickness of said head piece.

19. The bridle of claim 9, wherein:
a) said cushion is about twice in thickness than said head piece.

20. The bridle of claim 1, wherein:
a) said head straps and said portion of said nose band strap form a substantially planar top surface.
